(19) United States
(12) Patent Application Publication
(10) Pub. No.: US 2023/0282920 A1
(43) Pub. Date: Sep. 7, 2023

(54) BATTERY PACK WITH DOUBLE SHEAR CONNECTION

(71) Applicant: MILWAUKEE ELECTRIC TOOL CORPORATION, Brookfield, WI (US)

(72) Inventors: Gurusiddeshwar Gudimani, Plymouth, WI (US); Cameron R. Schulz, Milwaukee, WI (US); John G. Marx, Hartford, WI (US); Wyatt R. Silha, Milwaukee, WI (US); Jeffrey M. Wackwitz, Waukesha, WI (US)

(21) Appl. No.: 18/178,198

(22) Filed: Mar. 3, 2023

Related U.S. Application Data
(60) Provisional application No. 63/316,820, filed on Mar. 4, 2022.

(51) Int. Cl. H01M 50/262; H01M 50/213; H01M 50/507; H01M 50/247; H01M 50/296

(52) U.S. Cl. CPC H01M 50/262; H01M 50/213; H01M 50/507; H01M 50/247; H01M 50/296; H01M 2220/30

(57) ABSTRACT

A battery pack is configured to be coupled to an electrical device. The battery pack includes a plurality of battery cells, a battery cell carrier to support the battery cells, a housing having an upper housing portion. The battery cell carrier having a plurality of connector screw bosses. The upper housing portion having an outer screw boss on each lateral side and a respective inner screw boss formed on an inner surface of the upper housing portion. The upper housing portion is connected to the battery cell carrier with a plurality of threaded fasteners each extending through one of the outer screw bosses, a respective one of the plurality of connector screw bosses, and a respective inner screw boss creating a double shear condition on each side of the respective connector screw boss.

### CROSS-REFERENCE TO RELATED APPLICATIONS

This application claims priority to co-pending U.S. Provisional Patent Application No. 63/316,820, filed on Mar. 4, 2022, the entire contents of which are incorporated herein by reference.

### FIELD

The invention generally relates to battery packs for use with electrical devices, such as tools, and, more particularly, to a battery cell module for a battery pack.

### SUMMARY

Cordless tools, such as power tools (e.g., drills, drivers, saws, nailers, grinders, etc.), outdoor tools (e.g., trimmers, pole saws, blowers, etc.), etc., and other electrical devices (e.g., motorized devices, non-motorized devices, chargers, etc.) (generally referred to herein as “devices” or a “device”) are powered by a rechargeable battery pack. The battery pack may be detached from a device for charging or for use with other devices.

In one independent aspect, battery pack is configured to be coupled to an electrical device. The battery pack includes a plurality of battery cells, a battery cell carrier configured to support the plurality of battery cells, a housing having an upper housing portion and a lower housing portion defining an internal compartment configured to receive the battery cell carrier. The battery cell carrier having a plurality of connector screw bosses formed on a top side. The upper housing portion having an outer screw boss on each lateral side and a respective inner screw boss formed on an inner surface of the upper housing portion. The upper housing portion is connected to the battery cell carrier with a plurality of first threaded fasteners each extending through one of the outer screw bosses, a respective one of the plurality of connector screw bosses, and a respective inner screw boss creating a double shear condition on each side of each of respective one of the plurality of connector screw bosses.

In some constructions, each of the outer screw bosses, the respective one of the plurality of connector screw bosses, and the respective inner screw bosses are aligned. In some constructions, each of the plurality of first threaded fasteners pass through the upper housing portion twice and on one side of the battery cell carrier. In some constructions, the lower housing portion is connected to the battery cell carrier with a plurality of second threaded fasteners. In some constructions, the electrical device is a power tool.

In some constructions, the battery cell carrier includes a first half portion and a second half portion. In some constructions, the first half portion and the second half portion are connected via a plurality of third threaded fasteners. In some constructions, the plurality of connector screw bosses is formed on the first half portion. In some constructions, each of the plurality of battery cells are cylindrical-shaped. In some constructions, the plurality of battery cells supported in the battery cell carrier are in a compact arrangement. In some constructions, the plurality of first threaded fasteners are screws.

In some constructions, the battery pack further includes a terminal block coupled to the battery cell carrier on the top side and providing electrical communication between the battery cell carrier and the electrical device. In some constructions, the battery cell carrier includes a plurality of cell connectors configured to engage with the cell terminals of each of the plurality of battery cells, and wherein the terminal block includes a plurality of strap elements each coupled to one of the plurality of cell connectors.

Other independent aspects of the invention may become apparent by consideration of the detailed description and accompanying drawings.

### BRIEF DESCRIPTION OF THE DRAWINGS

FIG. 1 is a top perspective view of a battery pack operable with an electrical device.

FIG. 2A is a top perspective of a lower housing of the battery pack of FIG. 1.

FIG. 2B is a perspective of the lower housing of the battery pack of FIG. 1.

FIG. 3A is a bottom perspective of an upper housing of the battery pack of FIG. 1.

FIG. 3B is another bottom perspective of the upper housing of the battery pack of FIG. 1.

FIG. 4A is a partially exploded top perspective view of an outer housing of the battery pack of FIG. 1.

FIG. 4B is another partially exploded top perspective view of the outer housing of the battery pack of FIG. 1.

FIG. 5 is a top perspective view of the battery pack of FIG. 1 with the upper housing removed.

FIG. 6A is a top perspective view of the internal components of the battery pack of FIG. 1.

FIG. 6B is another top perspective view of the internal components of the battery pack of FIG. 1.

FIG. 7A is a cross-sectional view of the battery pack of FIG. 1 along the lines 7A-7A of FIG. 1.

FIG. 7B is a cross-sectional view of the battery pack of FIG. 1 along the lines 7B-7B of FIG. 1.

FIG. 8 is a top perspective of a terminal block of the battery pack of FIG. 1.

### DETAILED DESCRIPTION

Before any independent embodiments of the invention are explained in detail, it is to be understood that the invention is not limited in its application to the details of construction and the arrangement of components set forth in the following description or illustrated in the following drawings. The invention is capable of other independent embodiments and of being practiced or of being carried out in various ways. Also, it is to be understood that the phraseology and terminology used herein is for the purpose of description and should not be regarded as limiting.

The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Relative terminology, such as, for example, “about”, “approximately”, “substantially”, etc., used in connection with a quantity or condition would be understood by those of ordinary skill to be inclusive of the stated value and has the meaning dictated by the context (for example, the term includes at least the degree of error associated with the measurement of, tolerances (e.g., manufacturing, assembly, use, etc.) associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10% or more) of an indicated value.

Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not listed.

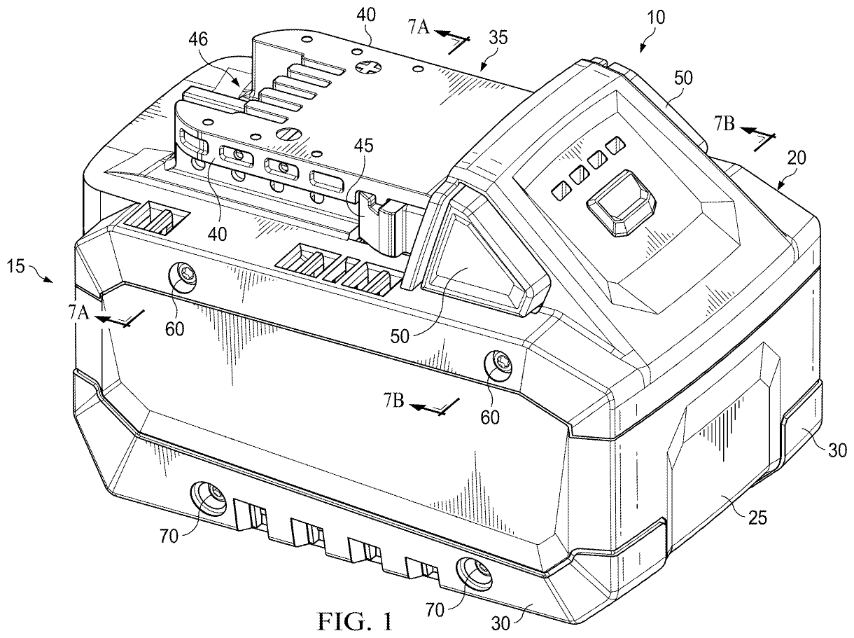

FIG. 1 illustrates a removable and rechargeable battery pack 10 operable to selectively power an electrical device (not shown; e.g., a power tool (e.g., a drill, a driver, a saw, a nailer, a grinder, etc.), an outdoor tool (e.g., a trimmer, a pole saw, etc.), etc., and another electrical device (e.g., a motorized device, a non-motorized device, etc.)). The battery pack 10 is also connectable to a charger (not shown) for charging.

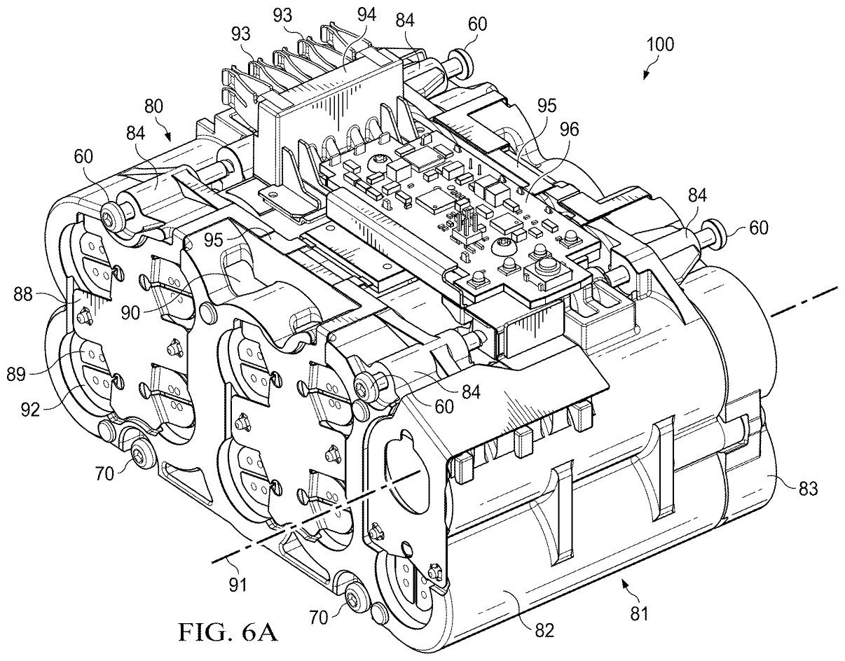

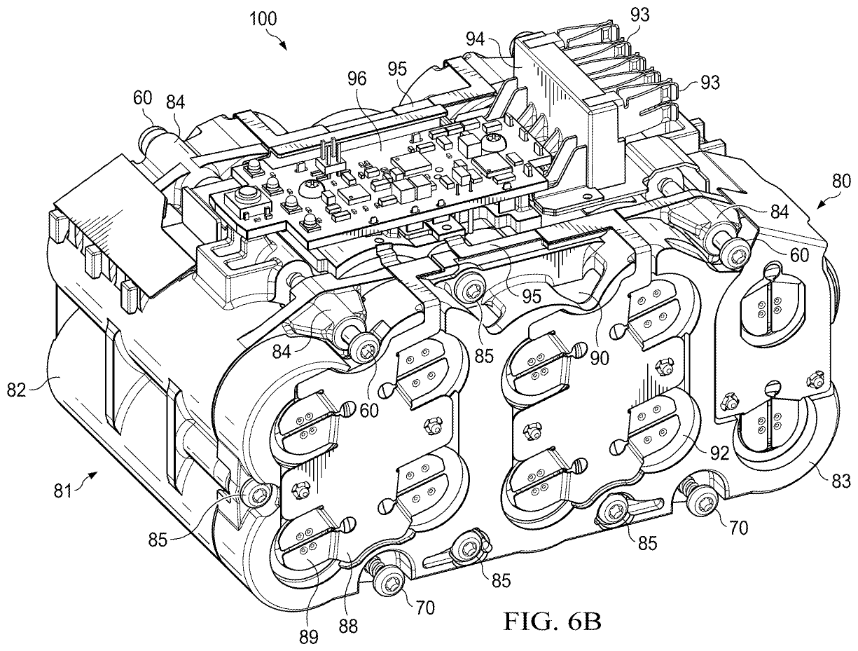

The battery pack 10 includes an outer housing 15 formed, in the illustrated construction, of an upper housing portion 20 and a lower housing portion 25. The battery pack 10 also includes a battery cell carrier 80 (e.g., a battery cell core; FIGS. 6A and 6B) coupled to the outer housing 15 between the upper housing portion 20 and the lower housing portion 25. In the illustrated construction, a pair of protective cap elements 30 are connected to the lower housing portion 25 at the bottom and on either lateral side.

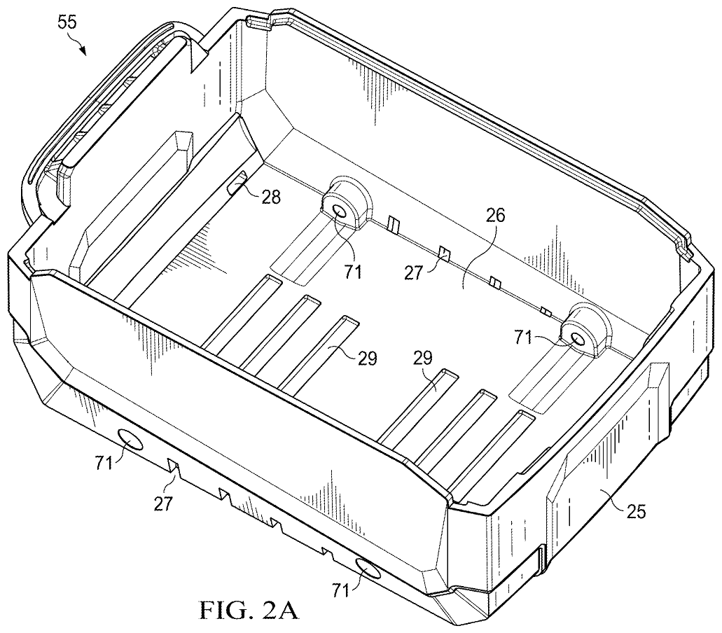

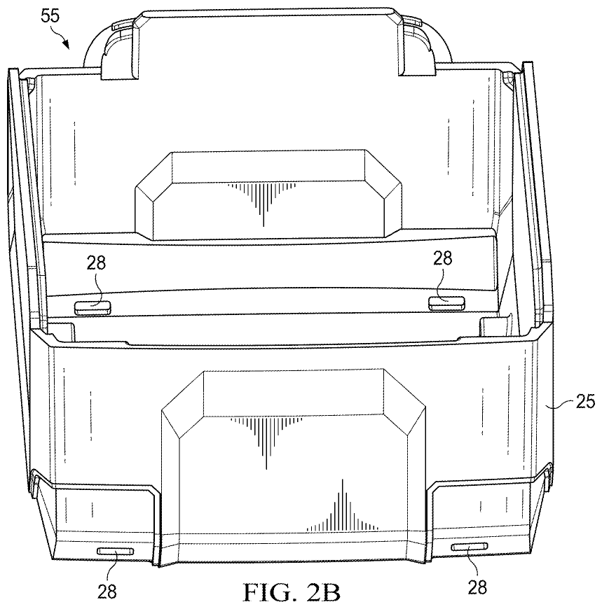

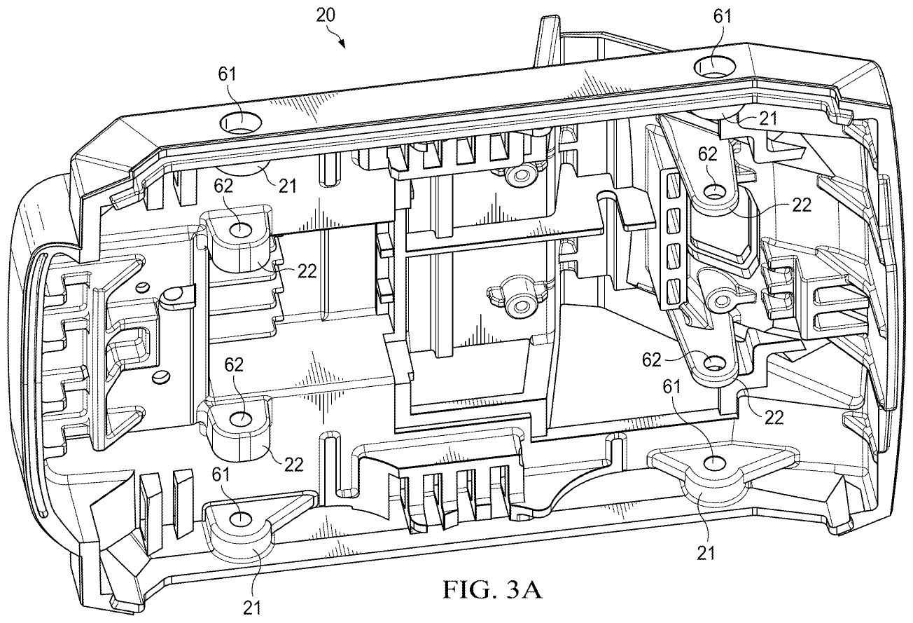

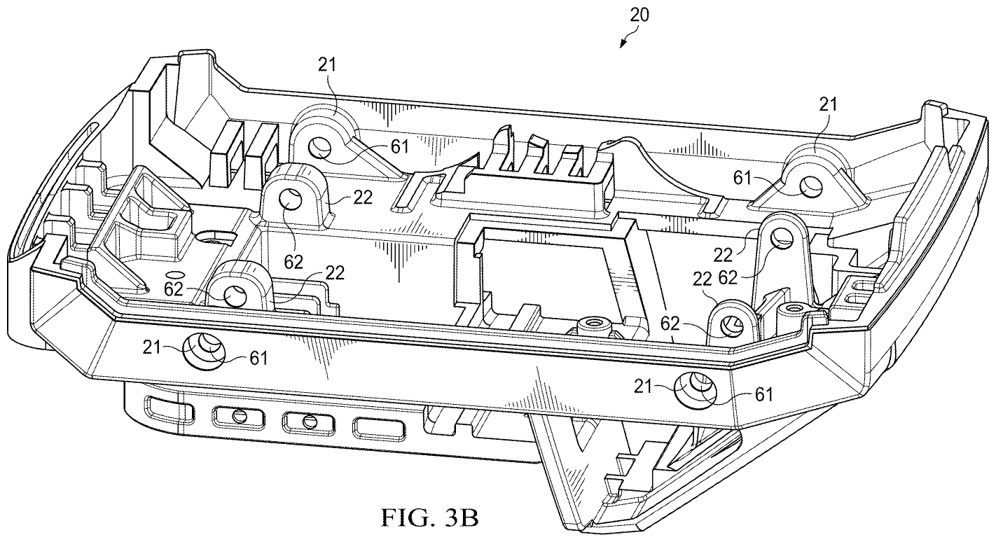

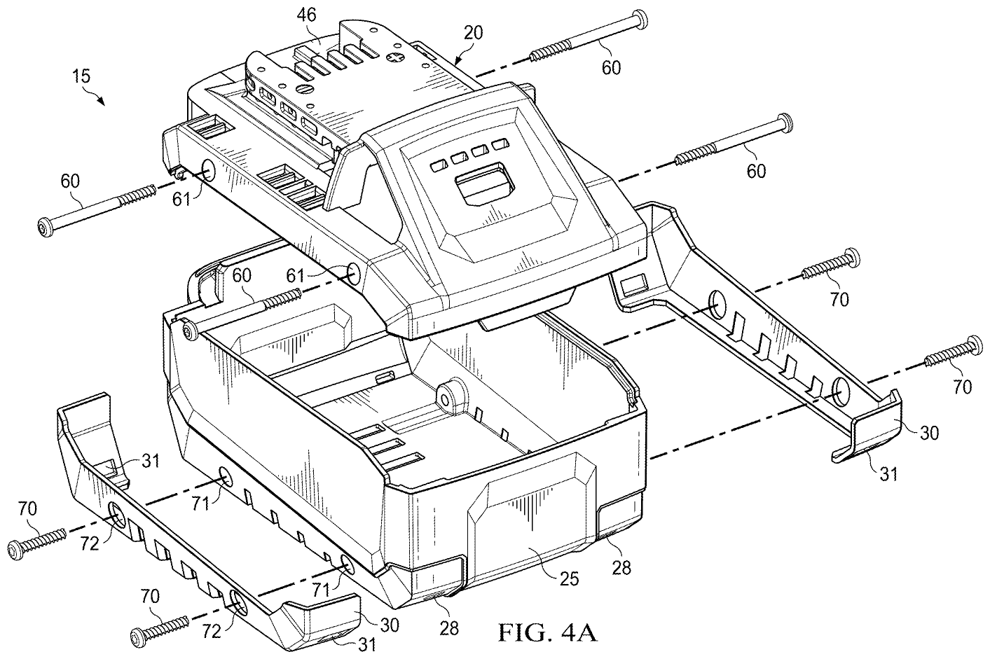

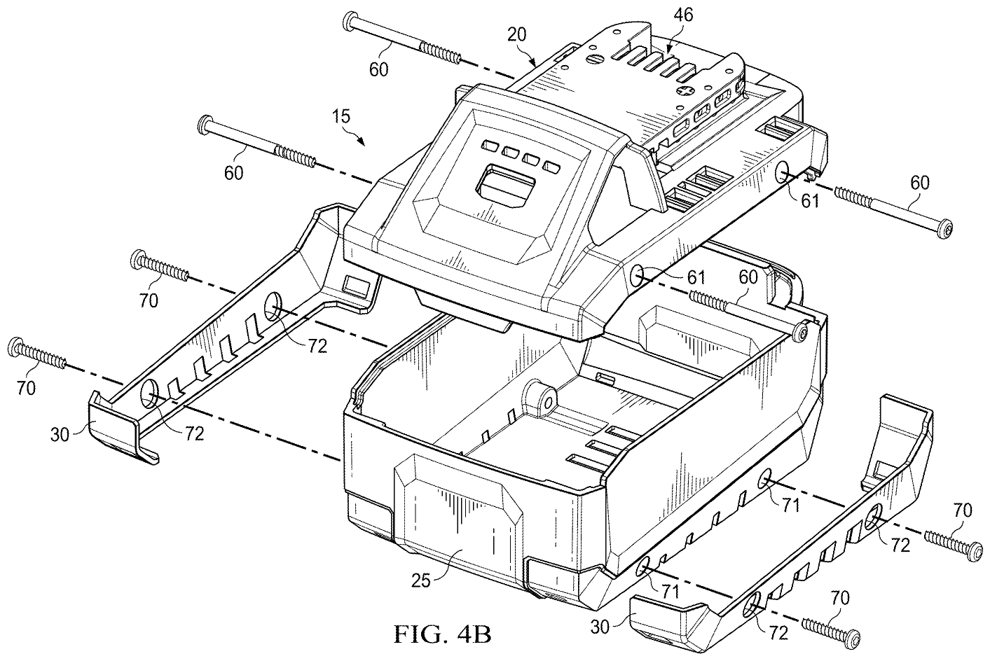

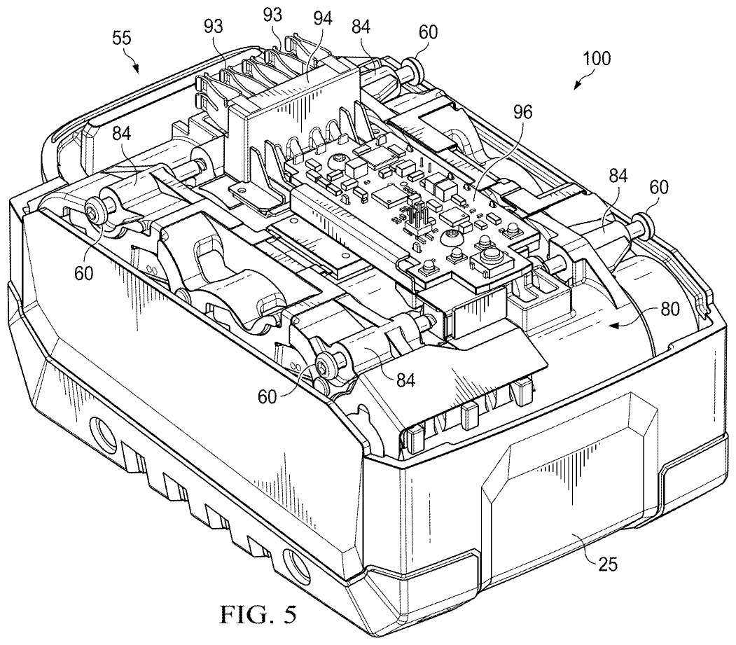

In the illustrated construction, the upper housing portion 20 is connected to the battery cell carrier 80 with threaded fasteners 60 (e.g., screws) that extend through complementary fastening holes 61 and 62 (FIGS. 3A-4B, 7A, 7B). In the illustrated construction, the lower housing portion 25 and the protective cap elements 30 are connected to the battery cell carrier 80 with threaded fasteners 70 that extend through complementary fastening holes 71 form in the lower housing portion 25 and complementary fastening holes 72 formed in each of the protective cap elements 30. In other constructions (not shown), the housing portions 20 and 25 and the protective cap elements 30 are connected with other suitable coupling means. Together, the upper housing portion 20 and the lower housing portion 25 define an internal compartment within the outer housing 15 containing internal components 100 (FIG. 5), including the battery cell carrier 80 of the battery pack 10. The internal compartment is formed primarily from the internal cavity 55 formed by the lower housing portion 25 (FIGS. 2A, 2B).

In the illustrated construction, the lower housing 25 (FIGS. 2A, 2B) includes a number of drainage holes 27 formed on the lateral sides and adjacent to a bottom surface 26. The lower housing 25 also includes drainage holes 28 formed on both the front and back sides and adjacent to a bottom surface 26. Each of the drainage holes 27 and 28 communicating between the inside of the lower housing 25 Four drainage holes 27 are depicted on each lateral side and two drainage holes 28 are depicted on each of the front and back sides; however, other constructions may include more or less drainage holes. In the illustrated construction, the lower housing 25 also includes vent holes 29 formed on the bottom surface 26 through which air flows into the outer housing 15 from the outside of the outer housing 15. Six vent holes 29 are depicted; however, other constructions may include more or less vent holes.

The upper housing portion 20 includes connection features 35 that are operable to selectively couple the battery pack 10 to an electrical device (e.g., a drill, a reciprocating saw, a grinder, etc.) (not shown). For example, the connection features 35 include rails 40 that are sized to slidably interface with the electrical device and at least one latch 45 that holds the battery pack 10 to the electrical device. At least one release actuator 50 is coupled to the upper housing portion 20 and is operable to move the latch 45 to detach the battery pack 10 from the electrical device. In other embodiments, the battery pack 10 can be coupled to a different implement (e.g., portable lighting, lawn care equipment such as lawn mowers, chainsaws, blowers, etc.). In further embodiments, the battery pack 10 can be configured as a stem-style battery pack. Terminal openings 46 are formed in the connection features 35 adjacent battery pack terminals 93 (FIGS. 5-6B, and 8). The terminal openings 46 provide access to the battery pack terminals 93 to provide an electrical connection between the battery pack 10 and the electrical device

With reference to FIG. 5, the battery cell carrier 80 supported inside the outer housing 15 within the internal compartment. In the illustrated construction, the battery cell carrier 80 is received within a cavity 55 of the lower housing portion 25 for the lower housing portion 25 to support the battery cell carrier 80.

With reference to FIGS. 6A and 6B, the battery cell carrier 80 includes a module frame 81 that supports battery cells 90 (e.g., cylindrical-shaped battery cells) in a compact arrangement within the battery pack 10. In the illustrated construction, the module frame 81 includes first and second frame halves 82, 83 connected with threaded fasteners 85 (e.g., screws) (FIG. 6B). When assembled, the frame halves 82, 83 define a cell compartment (not shown) in which the battery cells 90 are positioned and secured. The battery cells 90 extend along respective longitudinal axes 91, and the frame halves 82, 83 support the opposite axial ends of each cell 90.

The battery cell carrier 80 also includes a circuit board 96 coupled to a terminal block 94 on the top surface (e.g., top side) of the battery cell carrier 80. The circuit board 96 and is in electrical communication with the cell connectors 88 and the battery pack terminals 93. The illustrated cell connectors 88 are coupled to lateral sides of the module frame 81 and include contacts 89 that extend through openings formed in the module frame 81 to engage the cell terminals 92 at the ends of the battery cells 90. The cell connectors 88 electrically connect cell terminals 92 of the battery cells 90 with the battery pack terminals 93.

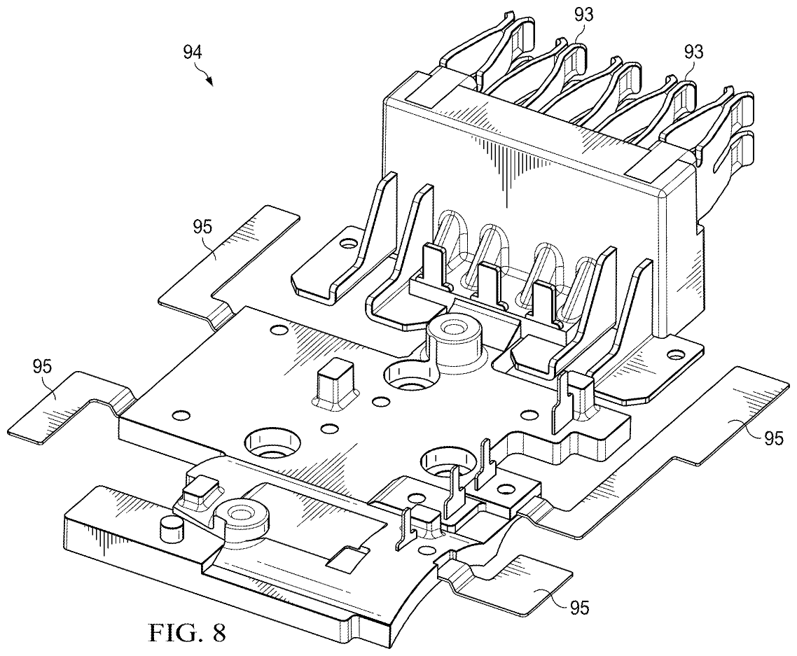

The illustrated battery pack terminals 93 are also coupled to the terminal block 94 on the top side of the battery cell carrier 80 and provides electrical communication between the battery cell carrier 80 and the electrical device when the battery pack 10 is coupled to the electrical device. In some constructions, the battery cell carrier 80 includes a nominal voltage of about 18 volts. In other constructions, the nominal voltage of the battery cell carrier 80 can be greater or less than 18 volts (e.g., 12 volts, 40 volts, etc.). In the illustrated construction, the terminal block 94 includes strap elements 95 (FIGS. 6A, 6B, 8) that are coupled to the cell connectors 88 via laser welding.

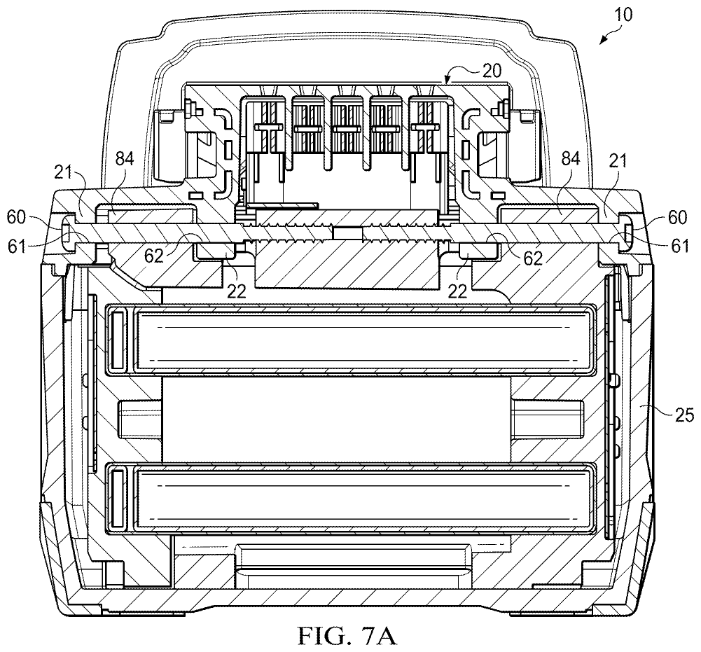

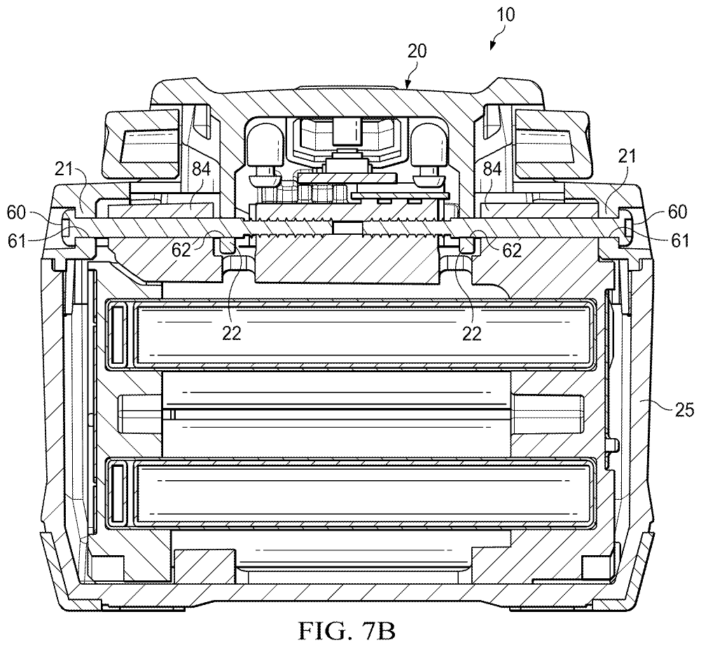

With reference to FIGS. 3A, 3B, 7A, and 7B the upper housing portion 20 is connected to the battery cell carrier 80 with threaded fasteners 60 that extend through complementary fastening holes 61 and 62 and through a one of the screw bosses 84 formed on the first frame half 82 and the screw bosses 21 and 22 formed in the upper housing portion 20 creating a double shear condition on each side of each of the screw bosses 84. In the depicted construction, the threaded fasteners 60 pass through the upper housing portion 20 twice on each side of the battery cell carrier 80 via the external screw bosses 21 forming fastening holes 61 and the internal screw bosses 22 forming fastening holes 22.

One or more independent features and/or independent advantages of the invention may be set forth in the claims.

### Example Configurations

Various aspects of the present disclosure may take any one or more of the following example configurations:
EEE(1) A battery pack configured to be coupled to an electrical device, the battery pack comprising: a plurality of battery cells; a battery cell carrier configured to support the plurality of battery cells, the battery cell carrier having a plurality of connector screw bosses formed on a top side; a housing having an upper housing portion and a lower housing portion defining an internal compartment configured to receive the battery cell carrier, the upper housing portion having an outer screw boss on each lateral side and a respective inner screw boss formed on an inner surface of the upper housing portion; and wherein the upper housing portion is connected to the battery cell carrier with a plurality of first threaded fasteners each extending through one of the outer screw bosses, a respective one of the plurality of connector screw bosses, and a respective inner screw boss creating a double shear condition on each side of each of respective one of the plurality of connector screw bosses.
EEE(2) The battery pack according to EEE(1), wherein the housing includes a lower housing portion.
EEE(3) The battery pack according to EEE(1) or EEE(2), wherein the upper housing portion and the lower housing portion define an internal compartment configured to receive the battery cell carrier.
EEE(4) The battery pack according to any one of EEE(1) to EEE(3), wherein each of the outer screw bosses, the respective one of the plurality of connector screw bosses, and the respective inner screw bosses are aligned.
EEE(5) The battery pack according to any one of EEE(1) to EEE(4), wherein each of the plurality of first threaded fasteners pass through the upper housing portion twice and on one side of the battery cell carrier.
EEE(6) The battery pack according to any one of EEE(1) to EEE(5), wherein the lower housing portion is connected to the battery cell carrier with a plurality of second threaded fasteners.
EEE(7) The battery pack according to any one of EEE(1) to EEE(6), wherein the electrical device is a power tool.
EEE(8) The battery pack according to any one of EEE(1) to EEE(7), wherein the battery cell carrier includes a first half portion and a second half portion.
EEE(9) The battery pack according to any one of EEE(1) to EEE(8), wherein the first half portion and the second half portion are connected via a plurality of third threaded fasteners.
EEE(10) The battery pack according to any one of EEE(1) to EEE(9), wherein the plurality of connector screw bosses is formed on the first half portion.
EEE(11) The battery pack according to any one of EEE(1) to EEE(10), wherein each of the plurality of battery cells are cylindrical-shaped.
EEE(12) The battery pack according to any one of EEE(1) to EEE(11), wherein the plurality of battery cells supported in the battery cell carrier are in a compact arrangement.
EEE(13) The battery pack according to any one of EEE(1) to EEE(12), wherein the plurality of first threaded fasteners are screws.
EEE(14) The battery pack according to any one of EEE(1) to EEE(13), further comprising a terminal block coupled to the battery cell carrier on the top side and providing electrical communication between the battery cell carrier and the electrical device.
EEE(15) The battery pack according to any one of EEE(1) to EEE(14), wherein the battery cell carrier includes a plurality of cell connectors configured to engage with the cell terminals of each of the plurality of battery cells, and wherein the terminal block includes a plurality of strap elements each coupled to one of the plurality of cell connectors.
EEE(16) A battery pack configured to be coupled to an electrical device, the battery pack comprising: a plurality of battery cells; a battery cell carrier configured to support the plurality of battery cells, the battery cell carrier having a plurality of connector screw bosses formed on a top side; a terminal block coupled to the battery cell carrier on the top side and providing electrical communication between the battery cell carrier and the electrical device; a housing having an upper housing portion comprising an outer screw boss on each lateral side and a respective inner screw boss formed on an inner surface of the lower housing portion; and wherein the upper housing portion is connected to the battery cell carrier with a plurality of first threaded fasteners each extending through one of the outer screw bosses, a respective one of the plurality of connector screw bosses, and a respective inner screw boss creating a double shear condition on each side of each of respective one of the plurality of connector screw bosses.
EEE(17) The battery pack according to EEE(16), wherein the housing includes a lower housing portion.
EEE(18) The battery pack according to EEE(16) or EEE(17), wherein the upper housing portion and the lower housing portion define an internal compartment configured to receive the battery cell carrier.
EEE(19) The battery pack according to any one of EEE(16) to EEE(18), wherein each of the outer screw bosses, the respective one of the plurality of connector screw bosses, and the respective inner screw bosses are aligned.
EEE(20) The battery pack according to any one of EEE(16) to EEE(19), wherein each of the plurality of first threaded fasteners pass through the upper housing portion twice and on one side of the battery cell carrier.
EEE(21) The battery pack according to any one of EEE(16) to EEE(20), wherein the lower housing portion is connected to the battery cell carrier with a plurality of second threaded fasteners.
EEE(22) The battery pack according to any one of EEE(16) to EEE(21), wherein the electrical device is a power tool.
EEE(23) The battery pack according to any one of EEE(16) to EEE(22), wherein the battery cell carrier includes a first half portion and a second half portion.
EEE(24) The battery pack according to any one of EEE(16) to EEE(23), wherein the first half portion and the second half portion are connected via a plurality of third threaded fasteners.
EEE(25) The battery pack according to any one of EEE(16) to EEE(24), wherein the plurality of connector screw bosses is formed on the first half portion.
EEE(26) The battery pack according to any one of EEE(16) to EEE(25), wherein each of the plurality of battery cells are cylindrical-shaped.
EEE(27) The battery pack according to any one of EEE(16) to EEE(26), wherein the plurality of battery cells supported in the battery cell carrier are in a compact arrangement.
EEE(28) The battery pack according to any one of EEE(16) to EEE(27), wherein the plurality of first threaded fasteners are screws.
EEE(29) A battery pack configured to be coupled to an electrical device, the battery pack comprising: a plurality of battery cells; a battery cell carrier configured to support the plurality of battery cells, the battery cell carrier having a plurality of connector screw bosses formed on a top side; a housing having an upper housing comprising an outer screw boss on each lateral side and a respective inner screw boss formed on an inner surface of the upper housing portion; and wherein the upper housing portion is connected to the battery cell carrier with a plurality of first threaded fasteners each extending through one of the outer screw bosses, a respective one of the plurality of connector screw bosses, and a respective inner screw boss creating a double shear condition on each side of each of respective one of the plurality of connector screw bosses, and wherein each of the outer screw bosses, the respective one of the plurality of connector screw bosses, and the respective inner screw bosses are aligned.
EEE(30) The battery pack according to EEE(29), wherein the housing includes a lower housing portion.
EEE(31) The battery pack according to EEE(29) or EEE(30), wherein the upper housing portion and the lower housing portion define an internal compartment configured to receive the battery cell carrier.
EEE(32) The battery pack according to any one of EEE(29) to EEE(31), wherein each of the plurality of first threaded fasteners pass through the upper housing portion twice and on one side of the battery cell carrier.
EEE(33) The battery pack according to any one of EEE(29) to EEE(32), wherein the lower housing portion is connected to the battery cell carrier with a plurality of second threaded fasteners.
EEE(34) The battery pack according to any one of EEE(29) to EEE(33), wherein the electrical device is a power tool.
EEE(35) The battery pack according to any one of EEE(29) to EEE(34), wherein the battery cell carrier includes a first half portion and a second half portion.
EEE(36) The battery pack according to any one of EEE(29) to EEE(35), wherein the first half portion and the second half portion are connected via a plurality of third threaded fasteners.
EEE(37) The battery pack according to any one of EEE(29) to EEE(36), wherein the plurality of connector screw bosses is formed on the first half portion.
EEE(38) The battery pack according to any one of EEE(29) to EEE(37), wherein each of the plurality of battery cells are cylindrical-shaped.
EEE(39) The battery pack according to any one of EEE(29) to EEE(38), wherein the plurality of battery cells supported in the battery cell carrier are in a compact arrangement.
EEE(40) The battery pack according to any one of EEE(29) to EEE(39), wherein the plurality of first threaded fasteners are screws.
EEE(41) The battery pack according to any one of EEE(29) to EEE(40), further comprising a terminal block coupled to the battery cell carrier on the top side and providing electrical communication between the battery cell carrier and the electrical device.
EEE(42) The battery pack according to any one of EEE(29) to EEE(41), wherein the battery cell carrier includes a plurality of cell connectors configured to engage with the cell terminals of each of the plurality of battery cells, and wherein the terminal block includes a plurality of strap elements each coupled to one of the plurality of cell connectors.

1. A battery pack configured to be coupled to an electrical device, the battery pack comprising:
a plurality of battery cells;
a battery cell carrier configured to support the plurality of battery cells, the battery cell carrier having a plurality of connector screw bosses formed on a top side;
a housing having an upper housing portion and a lower housing portion defining an internal compartment configured to receive the battery cell carrier, the upper housing portion having an outer screw boss on each lateral side and a respective inner screw boss formed on an inner surface of the upper housing portion; and
wherein the upper housing portion is connected to the battery cell carrier with a plurality of first threaded fasteners each extending through one of the outer screw bosses, a respective one of the plurality of connector screw bosses, and a respective inner screw boss creating a double shear condition on each side of each of respective one of the plurality of connector screw bosses.

2. The battery pack of claim 1, wherein each of the outer screw bosses, the respective one of the plurality of connector screw bosses, and the respective inner screw bosses are aligned.

3. The battery pack of claim 1, wherein each of the plurality of first threaded fasteners pass through the upper housing portion twice and on one side of the battery cell carrier.

4. The battery pack of claim 1, wherein the lower housing portion is connected to the battery cell carrier with a plurality of second threaded fasteners.

5. The battery pack of claim 1, wherein the electrical device is a power tool.

6. The battery pack of claim 1, wherein the battery cell carrier includes a first half portion and a second half portion.

7. The battery pack of claim 6, wherein the first half portion and the second half portion are connected via a plurality of third threaded fasteners.

8. The battery pack of claim 6, wherein the plurality of connector screw bosses is formed on the first half portion.

9. The battery pack of claim 1, wherein each of the plurality of battery cells are cylindrical-shaped.

10. The battery pack of claim 1, wherein the plurality of battery cells supported in the battery cell carrier are in a compact arrangement.

11. The battery pack of claim 1, wherein the plurality of first threaded fasteners are screws.

12. The battery pack of claim 1, further comprising a terminal block coupled to the battery cell carrier on the top side and providing electrical communication between the battery cell carrier and the electrical device.

13. The battery pack of claim 12, wherein the battery cell carrier includes a plurality of cell connectors configured to engage with the cell terminals of each of the plurality of battery cells, and wherein the terminal block includes a plurality of strap elements each coupled to one of the plurality of cell connectors.

14. A battery pack configured to be coupled to an electrical device, the battery pack comprising:
a plurality of battery cells;
a battery cell carrier configured to support the plurality of battery cells, the battery cell carrier having a plurality of connector screw bosses formed on a top side;
a terminal block coupled to the battery cell carrier on the top side and providing electrical communication between the battery cell carrier and the electrical device;
a housing having an upper housing portion comprising an outer screw boss on each lateral side and a respective inner screw boss formed on an inner surface of the lower housing portion; and
wherein the upper housing portion is connected to the battery cell carrier with a plurality of first threaded fasteners each extending through one of the outer screw bosses, a respective one of the plurality of connector screw bosses, and a respective inner screw boss creating a double shear condition on each side of each of respective one of the plurality of connector screw bosses.

15. The battery pack of claim 14, wherein the housing includes a lower housing portion, wherein the upper housing portion and the lower housing portion define an internal compartment configured to receive the battery cell carrier.

16. The battery pack of claim 15, wherein the lower housing portion is connected to the battery cell carrier with a plurality of second threaded fasteners.

17. The battery pack of claim 14, wherein the battery cell carrier includes a plurality of cell connectors configured to engage with the cell terminals of each of the plurality of battery cells, and wherein the terminal block includes a plurality of strap elements each coupled to one of the plurality of cell connectors.

18. A battery pack configured to be coupled to an electrical device, the battery pack comprising:
a plurality of battery cells;
a battery cell carrier configured to support the plurality of battery cells, the battery cell carrier having a plurality of connector screw bosses formed on a top side;
a housing having an upper housing comprising an outer screw boss on each lateral side and a respective inner screw boss formed on an inner surface of the upper housing portion; and
wherein the upper housing portion is connected to the battery cell carrier with a plurality of first threaded fasteners each extending through one of the outer screw bosses, a respective one of the plurality of connector screw bosses, and a respective inner screw boss creating a double shear condition on each side of each of respective one of the plurality of connector screw bosses, and
wherein each of the outer screw bosses, the respective one of the plurality of connector screw bosses, and the respective inner screw bosses are aligned.

19. The battery pack of claim 18, further comprising a terminal block coupled to the battery cell carrier on the top side and providing electrical communication between the battery cell carrier and the electrical device.

20. The battery pack of claim 19, wherein the battery cell carrier includes a plurality of cell connectors configured to engage with the cell terminals of each of the plurality of battery cells, and wherein the terminal block includes a plurality of strap elements each coupled to one of the plurality of cell connectors.
